(19) United States
(12) Patent Application Publication
(10) Pub. No.: US 2026/0296952 A1
(43) Pub. Date: Oct. 1, 2026

(54) Articles and Transparencies with Moderate Reflectance and Improved Aesthetics

(71) Applicant: Vitro Flat Glass LLC, Cheswick, PA (US)

(72) Inventors: Jianhua Li, Pittsburgh, PA (US); Patrick Fisher, Pittsburgh, PA (US); Paul A. Medwick, Wexford, PA (US); Andrew Wagner, Pittsburgh, PA (US)

(21) Appl. No.: 19/208,863

(22) Filed: May 15, 2025

Related U.S. Application Data
(60) Provisional application No. 63/778,460, filed on Mar. 27, 2025.

(51) Int. Cl. C03C 4/02; C03C 3/04; C03C 4/00; C03C 17/36

(52) U.S. Cl. CPC C03C 4/02; C03C 3/04; C03C 4/0092; C03C 17/366

(57) ABSTRACT

An article and a transparency including an exterior reflectance a* (Rg a*) of −2.5<Rg a*<2.5, an exterior reflectance b* (Rg b*) of 12>Rg b*>6, an interior reflectance a* (Rf a*) of −8<Rf a*<5, an interior reflectance b* (Rf b*) of −17<Rf b*<3, a transmitted a* (T a*) of −12<T a*<0 and a transmitted b* (Tb*) of −7<T b*<10 are provided.

### CROSS-REFERENCE TO RELATED APPLICATIONS

This application claims priority to U.S. Provisional Application No. 63/778,460, filed Mar. 27, 2025, the disclosure of which is incorporated by reference in its entirety.

### BACKGROUND OF THE INVENTION

### Field of the Invention

This invention relates generally to articles and transparencies having a light gold, soft warm gray, champagne color.

### Background of the Invention

Transparencies, such as windows, may include solar control coatings that block or filter selected ranges of electromagnetic radiation, typically radiation in the infrared region and/or ultraviolet region of the electromagnetic spectrum.

However, the accessible regions of the aesthetic/color space that are most broadly appealing and that can be reached using conventional solar control coatings employing one or more repeats of dielectric/silver/dielectric structures, are constrained by the designs of conventional solar control coatings.

Thus, it would be desirable to provide an article or transparency that provides an appealing champagne-like or soft-gray aesthetic/color, while also maintaining a high visible light transmittance, a low interior visible light reflectance, and a moderate exterior reflectance.

### SUMMARY OF THE INVENTION

The invention relates to an article comprising a substrate comprising a first surface and a second surface opposite the first surface. The article comprises: an exterior reflectance a* (Rg a*) of −2.5<Rg a*<2.5; an exterior reflectance b* (Rg b*) of 12>Rg b*>6; an interior reflectance a* (Rf a*) of −8<Rf a*<5; an interior reflectance b* (Rf b*) of −17<Rf b*<3; a transmitted a* (T a*) of −12<T a*<0; and a transmitted b* (T b*) of −7<T b*<10.

The invention also relates to a transparency comprising first substrate comprising a No. 1 surface and a No. 2 surface opposite the No. 1 surface a second substrate comprising a No. 3 surface and No. 4 surface opposite the No. 3 surface, wherein the second substrate is spaced apart from the first substrate, wherein the No. 3 surface faces the No. 2 surface, and wherein the first substrate and the second substrate are connected together. The transparency comprises: an exterior reflectance a* (Rg a*) of −2.5<Rg a*<2.5; an exterior reflectance b* (Rg b*) of 12>Rg b*>6; an interior reflectance a* (Rf a*) of −8<Rf a*<5; an interior reflectance b* (Rf b*) of −17<Rf b*<3; a transmitted a* (T a*) of −12<T a*<0; and a transmitted b* (T b*) of −7<T b*<10.

### BRIEF DESCRIPTION OF THE DRAWINGS

The invention will be described with reference to the following drawing figures wherein like reference numbers identify the parts throughout.

FIG. 1 is a plot depicting exterior reflectance a* and b* value ranges, interior reflectance a* and b* value ranges, and transmitted a* and b* value ranges for articles according to the invention.

FIG. 2 is a plot depicting exterior reflectance a* and b* value ranges, interior reflectance a* and b* value ranges, and transmitted a* and b* value ranges for articles according to the invention.

FIG. 3 is a plot depicting exterior reflectance a* and b* value ranges, interior reflectance a* and b* value ranges, and transmitted a* and b* value ranges for articles according to the invention.

FIG. 4 is a plot of the analyzed exterior reflected a* and b* values, interior reflected color a* and b* values, and the transmitted a* and b*values of Sample 1.

FIG. 5 is a plot of the analyzed exterior reflected a* and b* values, interior reflected color a* and b* values, and the transmitted a* and b*values of Sample 2.

FIG. 6 is a plot of the analyzed exterior reflected a* and b* values, interior reflected color a* and b* values, and the transmitted a* and b*values of Sample 7.

FIG. 7 is a plot of the analyzed exterior reflected a* and b* values, interior reflected color a* and b* values, and the transmitted a* and b*values of Sample 9.

### DESCRIPTION OF THE INVENTION

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate. The terms “visible region”, “visible light”, or “visible light spectrum” refer to electromagnetic radiation having a wavelength in the range of 380 nm to 800 nm. The terms “infrared region”, “infrared radiation”, or “infrared spectrum” refer to electromagnetic radiation having a wavelength in the range of greater than 800 nm to 100,000 nm. The terms “ultraviolet region”, “ultraviolet radiation”, or “ultraviolet (UV) spectrum” mean electromagnetic energy having a wavelength in the range of 300 nm to less than 380 nm. Additionally, all documents, such as, but not limited to, issued patents and patent applications, referred to herein are to be considered to be “incorporated by reference” in their entirety. As used herein, the term “film” refers to a coating region of a desired or selected coating composition. A “layer” can comprise one or more “films”, and a “coating” or “coating stack” can comprise one or more “layers”. The term “critical thickness” means a thickness above which a coating material forms a continuous, uninterrupted layer and below which is below the coating material's percolation threshold.

The invention is directed to an article. The article comprises a substrate comprising a first surface and a second surface opposite the first surface. The article comprises: an exterior reflectance a* (Rg a*) of −2.5<Rg a*<2.5; an exterior reflectance b* (Rg b*) of 12>Rg b*>6; an interior reflectance a* (Rf a*) of −8<Rf a*<5; an interior reflectance b* (Rf b*) of −17<Rf b*<3; a transmitted a* (T a*) of −12<T a*<0; and a transmitted b* (Tb*) of −7<T b*<10, as shown in FIG. 1.

The article 10 comprises a substrate 12. The substrate 12 can be of any desired material having any desired characteristics, such as opaque, translucent, or transparent to visible light. For example, the substrate 12 can be transparent or translucent to visible light. By “transparent” is meant having visible light transmission of greater than 0% up to 100%. Alternatively, the substrate 12 can be translucent. By “translucent” is meant allowing electromagnetic energy (e.g., visible light) to pass through but diffusing this energy such that objects on the side opposite the viewer are not clearly visible. Examples of suitable materials include, but are not limited to, plastic substrates (such as acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxane-containing polymers; or copolymers of any monomers for preparing these, or any mixtures thereof); ceramic substrates; glass substrates; or mixtures or combinations of any of the above. For example, the substrate 12 can be conventional soda-lime-silicate glass, borosilicate glass, or leaded glass. The glass can be clear glass. By “clear glass” is meant non-tinted or non-colored glass. Alternatively, the glass can be tinted or otherwise colored glass. The glass can be annealed or heat-treated glass. As used herein, the term “heat treated” means tempered or at least partially tempered. The glass can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. Examples of float glass processes are disclosed in U.S. Pat. Nos. 4,466,562 and 4,671,155.

The substrate 12 may comprise, for example, clear float glass or can be tinted or colored glass. The substrate 12 can be of any desired dimensions, e.g., length, width, shape, or thickness. In one non-limiting embodiment in which the substrate is an architectural transparency, the substrate 12 may be 1 mm to 30 mm thick, such as 2.5 mm to 25 mm thick, such as 2.5 mm to 10 mm. As used herein, the term “architectural transparency” refers to any transparency located on a building, such as, but not limited to, windows and sky lights. However, it is to be understood that the invention is not limited to use with such architectural transparencies but could be practiced with transparencies in any desired field, such as, but not limited to, laminated or non-laminated residential and/or commercial windows, insulating glass units, and/or transparencies for land, air, space, above water and underwater vehicles, as well as personal transparencies such as glasses and the like. Therefore, it is to be understood that the specifically disclosed exemplary embodiments are presented simply to explain the general concepts of the invention, and that the invention is not limited to these specific exemplary embodiments. Additionally, while a typical “transparency” can have sufficient visible light transmission such that materials can be viewed through the transparency, in the practice of the invention, the “transparency” need not be transparent to visible light but may be translucent or opaque.

In some embodiments, the substrate 12 can be a monolithic glazing. By “monolithic” is meant having a single structural support or structural member, e.g. having a single substrate.

The substrate 12 comprises a first surface 14 and a second surface 16. The second surface 16 is opposite the first surface 14.

A coating may be positioned over at least a portion of the first surface 14 of the substrate 12. Alternatively, a coating may be positioned over at least a portion of the second surface 16 of the substrate 12. The coating may be a solar control coating. For example, the solar control coating may comprise one or more repeats of dielectric/metallic/dielectric structures. For example, the coating may be a solar control coating consisting of three metallic layers.

As will be appreciated by one of skill in the art, the color of an object, and in particular glass, is highly subjective. Observed color will depend on the lighting conditions and preferences of the observer. The CIELAB color system, specified by the International Commission on Illumination, was developed in order to evaluate color on a quantitative basis, which specifies the color in terms of hue and lightness. Hue distinguishes colors such as red, yellow, green and blue. Lightness, or value, distinguishes the degree of lightness or darkness. The numerical values of these characteristics, which are identified as L*, a* and b*, are calculated from the tristimulus values (X, Y, Z). L* indicates the lightness or darkness of the color and represents the lightness plane on which the color resides. a* indicates the position of the color on a red (+a*) green (−a*) axis. b* indicates the color position on a yellow (+b*) blue (−b*) axis. When the rectangular coordinates of the CIELAB system are converted into cylindrical polar coordinates, the resulting color system is known as the CIELCH color system which specifies color in terms of lightness (L*), and hue angle (H°) and chroma (C*). L* indicates the lightness or darkness of the color as in the CIELAB system. Chroma, or saturation or intensity, distinguishes color intensity or clarity (i.e. vividness vs. dullness) and is the vector distance from the center of the color space to the measured color. The lower the chroma of the color, i.e. the less its intensity, the closer the color is to being a so-called neutral color. With respect to the CIELAB system, C*=(a*₂+b*₂)_{1/2}. Hue angle distinguishes colors such as red, yellow, green and blue and is a measure of the angle of the vector extending from the a*, b* coordinates through the center of the CIELCH color space measured counterclockwise from the red (+a*) axis.

The article 10 comprises an exterior reflectance b* (Rg b*) of 12>Rg b*>6. For example, the article 10 may comprise a Rg b* of 11.5>Rg b*>6. For example, the article 10 may comprise a Rg b* of 11>Rg b*>6. For example, the article 10 may comprise a Rg b* of 11.5>Rg b*>9. For example, the article 10 may comprise a Rg b* of 10>Rg b*>7.

The Rg b* is determined at an incident angle of 8 degrees) (° relative to normal of the article 10. As used herein the “incident angle” is defined as the angle between a ray of radiation incident on a surface of the article to a line normal to the surface at the point of incidence.

The article 10 comprises an exterior reflectance a* (Rg a*) of −2.5<Rg a*<2.5. For example, the article 10 may comprise a Rg a* of −2<Rg a*<2. For example, the article 10 may comprise a Rg a* of −1<Rg a*<1. The Rg a* is determined at an incident angle of 8° relative to normal of the article 10.

The article 10 comprises an interior reflectance a* (Rf a*) of −8<Rf a*<5. For example, the article 10 may comprise a Rf a* of −7<Rf a*<4. The Rf a* is determined at an incident angle of 8° relative to normal of the article 10.

The article 10 comprises an interior reflectance b* (Rf b*) of −17<Rf b*<3. For example, article 10 may comprise a Rf b* of −14<Rf b*<2. The Rf b* is determined at an incident angle of 8° relative to normal of the article 10.

The article 10 comprises a transmitted a* (T a*) of −12<T a*<0. For example, the article 10 may comprise a T a* of −7<T a*<−1. The T a* is determined at an incident angle of 8° relative to normal of the article 10.

The article 10 comprises a transmitted b* (T b*) of −7<T b*<10. For example, the article 10 may comprise a T b* of −6<T b*<9.5. The T b* is determined at an incident angle of 8° relative to normal of the article 10.

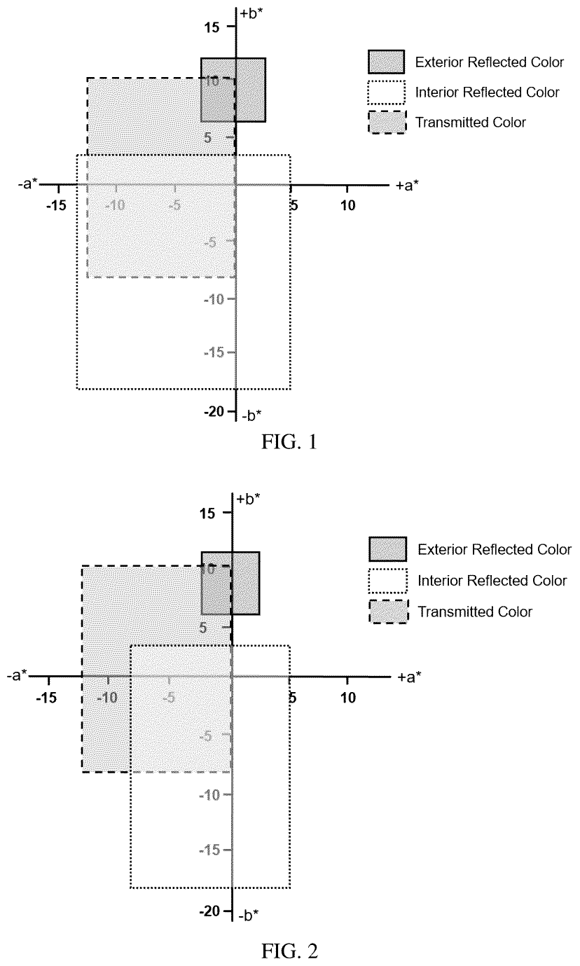

For example, the article 10 may comprise a Rg a* of −2<Rg a*<2, a Rg b* of 11>Rg b*>6, a Rf a* of −8<Rf a*<5, a Rf b* of −17<Rf b*<3, a Ta* of −12<Ta*<0, and a Tb* of −7<T b*<10, as shown in FIG. 2.

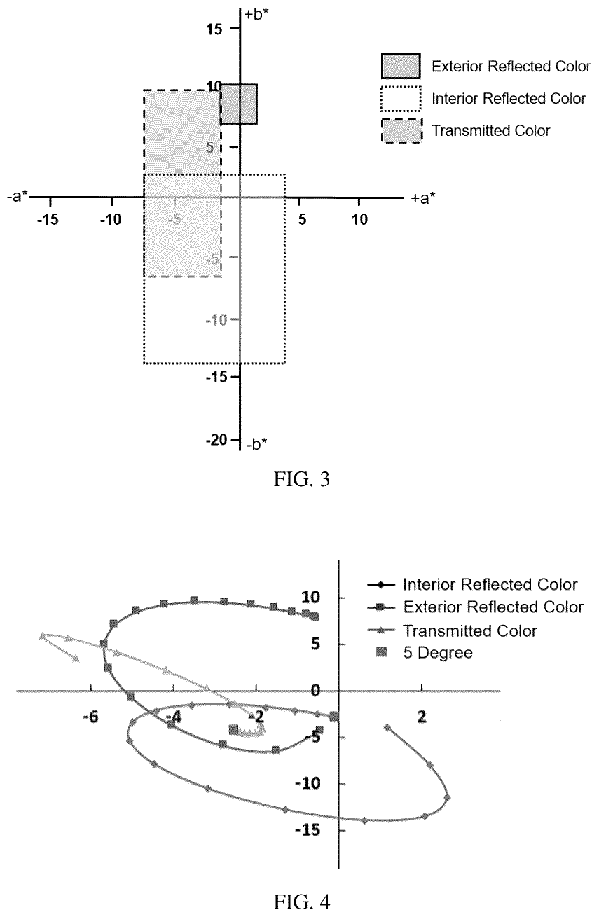

For example, the article 10 may comprise a Rg a* of −1<Rg a*<1, a Rg b* of 10>Rg b*>7, a Rf a* of −7<Rf a*<4, a Rf b* of −14<Rf b*<2, a Ta* of −7<Ta*<−1, and a Tb* of −6<T b*<9.5, as shown in FIG. 3.

The article 10 may further comprise an interior reflectance of less than or equal to 16%. For example, the article 10 may further comprise an interior reflectance of from 6% to 16%. For example, the article 10 may further comprise an interior reflectance of from 8% to 16%.

The article 10 may further comprise a visible light transmittance of at least 40%. For example, the article 10 may comprise a visible light transmittance in a range of from 40% to 50%.

The article 10 may further comprise an exterior reflectance in a range from 20% to 40%. Alternatively, the article 10 may further comprise an exterior reflectance of not greater than 26.5%. For example, the article 10 may further comprise an exterior reflectance in a range of from 25% to 26.5%. Alternatively, the article 10 may further comprise an exterior reflectance of at least 30%. Alternatively, the article 10 may further comprise an exterior reflectance of at least 35%.

The present invention is also directed to a transparency 200. For example, the transparency 200 may be used an architectural transparency or architectural glazing, such as, but not limited to, an insulating glass unit. The transparency 200 comprises a first substrate 212 comprising a No. 1 surface 214 and a No. 2 surface 216 opposite the No. 1 surface 214 and a second substrate 218 comprising a No. 3 surface 220 and No. 4 surface 222 opposite the No. 3 surface 220. In the illustrated non-limiting embodiment, the No. 1 surface 214 of the first substrate 212 faces the building exterior, i.e., is an outer major surface, and the No. 2 surface 216 faces the interior of the building. The second substrate 118 is spaced apart from the first substrate 212. The No. 3 surface 220 faces the No. 2 surface 216. In some embodiments, the transparency 200 may further comprise a third substrate with a No. 5 surface and No. 6 surface opposite the No. 5 surface. The substrates 212, 218 can have any desired visible light, infrared radiation, or ultraviolet radiation transmission and/or reflection. For example, the substrates 212, 218 can have a visible light transmission of any desired amount, e.g., greater than 0% up to 100%. The substrates 212, 218 can each be, for example, clear float glass or can be tinted or colored glass or one substrate 212, 218 can be clear glass and the other substrate 212, 218 colored glass. Although not limiting to the invention, examples of glass suitable for the first substrate 212 and/or second substrate 218 are described in U.S. Pat. Nos. 4,746,347; 4,792,536; 5,030,593; 5,030,594; 5,240,886; 5,385,872; and 5,393,593. Examples of insulating glass units are found, for example, in U.S. Pat. Nos. 4,193,236; 4,464,874; 5,088,258; and 5,106,663.

The first substrate 212 and the second substrate 218 are connected together in any suitable matter, such as, by being adhesively bonded to a conventional spacer frame 224. A gap or chamber 226 is formed between the first substrate 212 and the second substrate 218. The chamber 226 can be filled with a selected atmosphere, such as, air, or a non-reactive gas such as, argon or krypton gas.

A coating may be positioned over or in direct contact with at least a portion of the No. 2 surface 216 of the first substrate 212. Alternatively, a coating may be positioned over or in direct contact with the No. 3 surface 220 of the second substrate 218. The coating may be a solar control coating. For example, the solar control coating may comprise one or more repeats of dielectric/metallic/dielectric structures. For example, the coating may be a solar control coating consisting of three metallic layers. When present, the coating is not on the No. 1 surface 214 of the first substrate 212 or the No. 4 surface 222 of the second substrate 218.

The transparency 200 comprises an exterior reflectance Rg b* of 12>Rg b*>6. For example, the transparency 200 may comprise a Rg b* of 11.5>Rg b*>6. For example, the transparency 200 may comprise a Rg b* of 11>Rg b*>6. For example, the transparency 200 may comprise a Rg b* of 11.5>Rg b*>9. For example, the transparency may comprise a Rg b* of 10>Rg b*>7. The Rg b* is determined at an incident angle of 8° relative to normal of the transparency 200.

The transparency 200 comprises an exterior reflectance a* (Rg a*) of −2.5<Rg a*<2.5. For example, the transparency 200 may comprise a Rg a* of −2<Rg a*<2. For example, the transparency 200 may comprise a Rg a* of −1<Rg a*<1. The Rg a* is determined at an incident angle of 8° relative to normal of the transparency 200.

The transparency 200 comprises an interior reflectance a* (Rf a*) of −8<Rf a*<5. For example, the transparency 200 may comprise a Rf a* of −7<Rf a*<4. The Rf a* is determined at an incident angle of 8° relative to normal of the transparency 200.

The transparency 200 comprises an interior reflectance b* (Rf b*) of −17<Rf b*<3. For example, the transparency 200 may comprise a Rf b* of −14<Rf b*<2. The Rf b* is determined at an incident angle of 8° relative to normal of the transparency 200.

The transparency 200 comprises a transmitted a* (T a*) of −12<T a*<0. For example, the transparency 200 may comprise a T a* of −7<T a*<−1. The T a* is determined at an incident angle of 8° relative to normal of the transparency 200.

The transparency 200 comprises a transmitted b* (T b*) of −7<T b*<12. For example, the transparency 200 may comprise a Tb* of −5.5<Tb*<10. The T b* is determined at an incident angle of 8° relative to normal of the transparency 200.

For example, the transparency 200 may comprise a Rg a* of −2<Rg a*<2, a Rg b* of 11>Rg b*>6, a Rf a* of −8<Rf a*<5, a Rf b* of −17<Rf b*<3, a T a* of −12<T a*<0, and a T b* of −7<Tb*<10, as shown in FIG. 2.

For example, the transparency 200 may comprise a Rg a* of −1<Rg a*<1, a Rg b* of 10>Rg b*>7, a Rf a* of −7<Rf a*<4, a Rf b* of −14<Rf b*<2, a T a* of −7<T a*<−1, and a T b* of −6<T b*<9.5, as shown in FIG. 3.

The transparency 200 may further comprise an interior reflectance of less than or equal to 16%. For example, the transparency 200 may further comprise an interior reflectance of from 6% to 16%. For example, the transparency 200 may further comprise an interior reflectance of from 8% to 16%.

The transparency 200 may further comprise a visible light transmittance of at least 40%. For example, transparency 200 may further comprise a visible light transmittance in a range of from 40% to 50%.

The transparency 200 may further comprise an exterior reflectance in a range from 20% to 40%. Alternatively, the transparency 200 may further comprise an exterior reflectance of not greater than 26.5%. For example, transparency 200 may further comprise an exterior reflectance in a range of from 25% to 26.5%. Alternatively, the transparency 200 may further comprise an exterior reflectance of at least 30%. Alternatively, the transparency 200 may further comprise an exterior reflectance of at least 35%.

The following numbered clauses are illustrative of various aspects of the invention:

Clause 1: An article comprising: a substrate comprising a first surface and a second surface opposite the first surface; wherein the article comprises: an exterior reflectance a* (Rg a*) of −2.5<Rg a*<2.5; an exterior reflectance b* (Rg b*) of 12>Rg b*>6; an interior reflectance a* (Rf a*) of −8<Rf a*<5; an interior reflectance b* (Rf b*) of −17<Rf b*<3; a transmitted a* (T a*) of −12<T a*<0; and a transmitted b* (T b*) of −7<T b*<10. Clause 2: The article of clause 1, wherein the Rg a* is −2<Rg a*<2.

Clause 3: The article of clause 1 or 2, wherein the Rg a* is −1<Rg a*<1.

Clause 4: The article of any one of clauses 1 to 3, wherein the Rg b* is 11.5>Rg b*>6.

Clause 5: The article of any one of clauses 1 to 3, wherein the Rg b* is 11>Rg b*>6.

Clause 6: The article of any one of clauses 1 to 3, wherein the Rg b* is 11.5>Rg b*>9.

Clause 7: The article of any one of clauses 1 to 3, wherein the Rg b* is 10>Rg b*>7.

Clause 8: The article of any one of clauses 1 to 7, wherein the Rf a* is −7<Rf a*<4.

Clause 9: The article of any one of clauses 1 to 7, wherein the Rf b* is −14<Rf b*<2.

Clause 10: The article of any one of clauses 1 to 9, wherein the T a* is −7<T a*<−1.

Clause 11: The article of any one of clauses to 1 to 10, wherein the T b* is −6<T b*<9.5.

Clause 12: The article of any one of clauses 1 to 11, wherein the article further comprises an exterior reflectance in a range from 20% to 40%.

Clause 13: The article of any one of clauses 1 to 12, wherein the article comprises an exterior reflectance of not greater than 26.5%.

Clause 14: The article of any one of clauses 1 to 12, wherein the article further comprises an exterior reflectance of at least 30%.

Clause 15: The article of any one of clauses 1 to 12, wherein the article further comprises an exterior reflectance of at least 35%.

Clause 16: The article of any one of clauses 1 to 15, wherein the article further comprises a visible light transmittance of at least 40%.

Clause 17: The article of clause 16, wherein the visible light transmittance is in a range of from 40% to 50%.

Clause 18: The article of any one of clauses 1 to 16, wherein the article further comprises an interior reflectance of less than or equal to 16%.

Clause 19: The article of clause 18, wherein the interior reflectance is in a range of from 8% to 16%.

Clause 20: The article of any one of clauses 1 to 19, wherein the substrate comprises glass.

Clause 21: A transparency comprising: a first substrate comprising a No. 1 surface and a No. 2 surface opposite the No. 1 surface; a second substrate comprising a No. 3 surface and No. 4 surface opposite the No. 3 surface, wherein the second substrate is spaced apart from the first substrate, wherein the No. 3 surface faces the No. 2 surface, and wherein the first substrate and the second substrate are connected together, wherein the transparency comprises: an exterior reflectance a* (Rg a*) of −2.5<Rg a*<2.5; an exterior reflectance b* (Rg b*) of 12>Rg b*>6; an interior reflectance a* (Rf a*) of −8<Rf a*<5; an interior reflectance b* (Rf b*) of −17<Rf b*<3; a transmitted a* (T a*) of −12<T a*<0; and a transmitted b* (Tb*) of −7<Tb*<10.

Clause 22: The transparency of clause 21, wherein the Rg a* is −2<Rg a*<2.

Clause 23: The transparency of clause 21, wherein the Rg a* is −1<Rg a*<1.

Clause 24: The transparency of any one of clauses 21 to 23, wherein the Rg b* is 11.5>Rg b*>6.

Clause 25: The transparency of any one of clauses 21 to 23, wherein the Rg b* is 11>Rg b*>6.

Clause 26: The transparency of any one of clauses 21 to 23, wherein the Rg b* is 11.5>Rg b*>9.

Clause 27: The transparency of any one of clauses 21 to 23, wherein the Rg b* is 10>Rg b*>7.

Clause 28: The transparency of any one of clauses 23 to 27, wherein the Rf a* is −7<Rf a*<4.

Clause 29: The transparency of any one of clauses 23 to 28, wherein the Rf b* is −14<Rf b*<2.

Clause 30: The transparency of any one of clauses 23 to 29, wherein the T a* is −7<T a*<−1.

Clause 31: The transparency of any one of clauses 23 to 29, wherein the T b* is −6<T b*<9.5.

Clause 32: The transparency of any one of clauses 23 to 31, wherein the transparency further comprises an exterior reflectance in a range from 20% to 40%.

Clause 33: The transparency of any one of clauses 23 to 32, wherein the transparency comprises an exterior reflectance of not greater than 26.5%.

Clause 34: The transparency of any one of clauses 23 to 32, wherein the transparency comprises an exterior reflectance of at least 30%.

Clause 35: The transparency of any one of clauses 23 to 32, wherein the transparency comprises an exterior reflectance of at least 35%.

Clause 36: The transparency of any one of clauses 23 to 35, wherein the transparency further comprises a visible light transmittance of at least 40%.

Clause 37: The transparency of clause 36, wherein the visible light transmittance is in a range of from 40% to 50%.

Clause 38: The transparency of any one of clauses 23 to 37, wherein the transparency further comprises an interior reflectance of less than or equal to 16%.

Clause 39: The transparency of clause 39, wherein the interior reflectance is in a range of from 8% to 16%.

Clause 40: The transparency of any one of clauses 23 to 39, wherein the first substrate and the second substrate comprises glass.

The following Examples illustrate various embodiments of the invention. However, it is to be understood that the invention is not limited to these specific embodiments.

### EXAMPLES

### Example 1

Samples 1-3 were modeled with different coatings on a glass substrate.

Table 1 shows the resulting performance properties for Samples 1-3. In Table 1, the visible light transmittance is LTA, exterior reflectance is Rₑₓₜ, interior reflectance is Rᵢₙₜ, the solar heat gain coefficient is SHGC, heat transfer coefficient is U-value, and the light solar gain is LSG. Table 2 shows the resulting color properties of Samples 1-3, as determined at an incident angle of 8° relative to normal of the article.

TABLE 1

| Sample | LTA | Rₑₓₜ | Rᵢₙₜ | SHGC | LSG |
|---|---|---|---|---|---|
| 1 | 43.0% | 31.9% | 9.7% | 0.25 | 1.83 |
| 2 | 39.0% | 38.0% | 12.3% | 0.23 | 1.84 |
| 3 | 50.2% | 24.9% | 11.8% | 0.27 | 1.92 |

TABLE 2

| | Transmitted (T) | | Exterior Reflected (Rg) | | Interior Reflected (Rf) | |
|---|---|---|---|---|---|---|
| Sample | a* | b* | a* | b* | a* | b* |
| 1 | −2.49 | −4.32 | −0.7 | 8.07 | −0.36 | −2.63 |
| 2 | −2.79 | −4.93 | −0.09 | 8 | 0.4 | −0.46 |
| 3 | −4.38 | −2.44 | 2.89 | 10 | 3.6 | 1.86 |

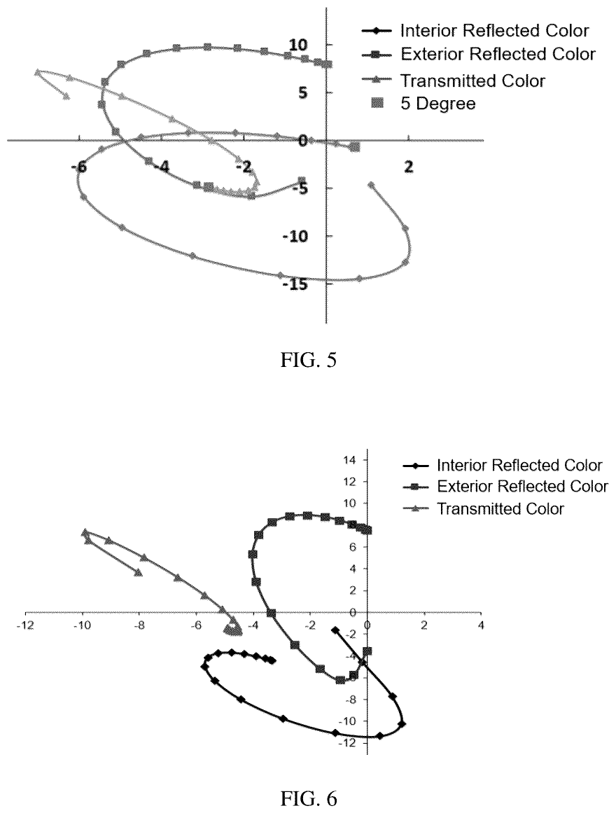

Plots of the analyzed interior reflected color (a* and b*), the exterior reflected color (a* and b*), and the transmitted color (a* and b*) of Samples 1 and 2 are provided in FIGS. 4 and 5, respectively.

Samples 4-6 were glass substrates coated with different coatings. The resulting performance properties of Samples 4-6 can be found in Tables 3 and 4. The color properties, as provided in Table 4, were determined at an incident angle of 8° relative to normal of the article.

TABLE 3

| Sample | LTA | Rₑₓₜ | Rᵢₙₜ | SHGC | U-value (winter) | LSG |
|---|---|---|---|---|---|---|
| 4 | 40.3% | 31.2% | 13.3% | 0.22 | 0.29 | 1.81 |
| 5 | 37.5% | 38.6% | 17.9% | 0.22 | 0.29 | 1.74 |
| 6 | 36.9% | 37.1% | 16.0% | 0.22 | 0.29 | 1.7 |

TABLE 4

| | Transmitted (T) | | Exterior Reflected (Rg) | | Interior Reflected (Rf) | |
|---|---|---|---|---|---|---|
| Sample | a* | b* | a* | b* | a* | b* |
| 4 | −5.74 | −4.25 | 0.63 | 9.57 | −0.86 | −3.36 |
| 5 | −6.99 | −9.05 | 1.09 | 9.24 | −6.85 | −2.85 |
| 6 | −4.74 | −4.48 | 0.77 | 8.67 | −2.66 | −1.74 |

### Example 2

Sample 7 was modeled with a coating on a glass substrate. A sample having two glass substrates, Sample 8, was modeled with the same coating as Sample 7. In Sample 8, the coating was positioned on the No. 2 surface or the No. 3 surface. Sample 9 was a glass substrate coated with a coating. Tables 5 and 6 show the resulting performance properties and color properties, respectively, for Samples 7, 8, and 9. The color properties, as provided in Table 6, were determined at an incident angle of 8° relative to normal of the article or transparency.

TABLE 5

| Sample | LTA | Rₑₓₜ | Rᵢₙₜ | SHGC | LSG |
|---|---|---|---|---|---|
| 7 | 55% | 22% | 7% | 0.28 | 2.13 |
| 8 | 47% | 26% | 11% | 0.27 | 2.13 |
| 9 | 44.4% | 26.3% | 11.9% | 0.24 | 1.82 |

TABLE 6

| | Transmitted (T) | | Exterior Reflected (Rg) | | Interior Reflected (Rf) | |
|---|---|---|---|---|---|---|
| Sample | a* | b* | a* | b* | a* | b* |
| 7 | −2.35 | −4.43 | 1.13 | 11.51 | −1.87 | −9.22 |
| 8 | −3.27 | −2.86 | −0.15 | 10.03 | −0.98 | −9.37 |
| 9 | −5.39 | −5.11 | 2.18 | 9.32 | 0.85 | −5.95 |

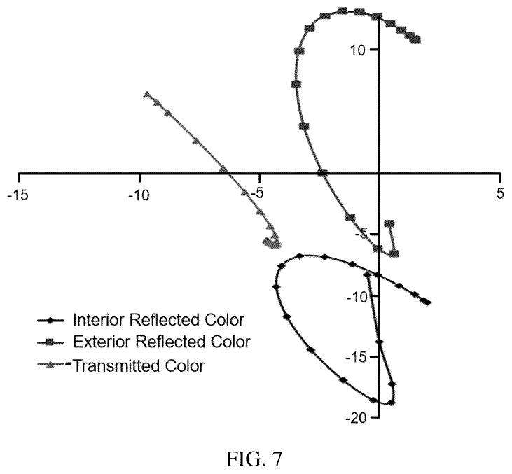

Plots of the analyzed interior reflected color (a* and b*), the exterior reflected color (a* and b*), and the transmitted color (a* and b*) of Samples 7 and 9 are provided in FIGS. 6 and 7, respectively.

Glass substrates were coated with different coatings to form Samples 10-12. The resulting performance properties of Samples 10-12 can be found in Tables 7 and 8. The color properties, as provided in Table 8, were determined at an incident angle of 8° relative to normal of the article.

TABLE 7

| Sample | LTA | Rₑₓₜ | Rᵢₙₜ | SHGC |
|---|---|---|---|---|
| 10 | 51% | 25% | 8% | 0.258 |
| 11 | 52% | 25% | 7% | 0.261 |
| 12 | 52% | 23% | 6% | 0.264 |

TABLE 8

| | Transmitted (T) | | Exterior Reflected (Rg) | | Interior Reflected (Rf) | |
|---|---|---|---|---|---|---|
| Sample | a* | b* | a* | b* | a* | b* |
| 10 | −4.17 | −5.21 | 1.58 | 9.88 | −1.9 | −15.59 |
| 11 | −4.36 | −5.25 | 1.57 | 10.82 | −1.84 | −16.09 |
| 12 | −4.65 | −5.01 | 2.2 | 10.4 | −1.04 | −16.73 |

Samples 10, 11, and 12 exhibited a metallic light gold color.

It will be readily appreciated by those skilled in the art that modification may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. An article comprising:
a substrate comprising a first surface and a second surface opposite the first surface, wherein the article comprises:
an exterior reflectance a* (Rg a*) of −2.5<Rg a*<2.5;
an exterior reflectance b* (Rg b*) of 12>Rg b*>6;
an interior reflectance a* (Rf a*) of −8<Rf a*<5;
an interior reflectance b* (Rf b*) of −17<Rf b*<3;
a transmitted a* (T a*) of −12<T a*<0; and
a transmitted b* (T b*) of −7<T b*<10.

2. The article of claim 1, wherein the Rg a* is −2<Rg a*<2.

3. The article of claim 1, wherein the Rg b* is 11.5>Rg b*>6.

4. The article of claim 1, wherein the Rg b* is 10>Rg b*>7.

5. The article of claim 1, wherein the Rf a* is −7<Rf a*<4.

6. The article of claim 1, wherein the Rf b* is −14<Rf b*<2.

7. The article of claim 1, wherein the T a* is −7<T a*<−1.

8. The article of claim 1, wherein the Tb* is −6<Tb*<9.5.

9. The article of claim 1, wherein the article further comprises:
an exterior reflectance of not greater than 26.5%;
a visible light transmittance of at least 40%; and
an interior reflectance of less than or equal to 16%.

10. A transparency comprising:
a first substrate comprising a No. 1 surface and a No. 2 surface opposite the No. 1 surface;
a second substrate comprising a No. 3 surface and No. 4 surface opposite the No. 3 surface,
wherein the second substrate is spaced apart from the first substrate,
wherein the No. 3 surface faces the No. 2 surface, and
wherein the first substrate and the second substrate are connected together;
wherein the transparency comprises:
an exterior reflectance a* (Rg a*) of −2.5<Rg a*<2.5;
an exterior reflectance b* (Rg b*) of 12>Rg b*>6;
an interior reflectance a* (Rf a*) of −8<Rf a*<5;
an interior reflectance b* (Rf b*) of −17<Rf b*<3;
a transmitted a* (T a*) of −12<T a*<0; and
a transmitted b* (T b*) of −7<T b*<10.

11. The transparency of claim 10, wherein the Rg a* is −2<Rg a*<2.

12. The transparency of claim 10, wherein the Rg b* is 11.5>Rg b*>6.

13. The transparency of claim 10, wherein the Rg b* is 10>Rg b*>7.

14. The transparency of claim 10, wherein the Rf a* is −7<Rf a*<4.

15. The transparency of claim 10, wherein the Rf b* is −14<Rf b*<2.

16. The transparency of claim 10, wherein the T a* is −7<T a*<−1.

17. The transparency of claim 10, wherein the T b* is −6<T b*<9.5.

18. The transparency of claim 10, wherein the transparency further comprises:
an exterior reflectance of not greater than 26.5%;
a visible light transmittance of at least 40%; and
an interior reflectance of less than or equal to 16%.
